(19) United States
(12) Patent Application Publication
(10) Pub. No.: US 2017/0025834 A1
(43) Pub. Date: Jan. 26, 2017

(54) LUMINESCENT WALL PLATES FOR LIGHT SWITCHES, ELECTRICAL OUTLETS, TELEPHONE AND DATA JACKS, CABLE TV JACKS AND OTHER ELECTRICAL CONNECTIONS AND DEVICES

(71) Applicant: Michael L. Milano, Boynton Beach, FL (US)

(72) Inventor: Michael L. Milano, Boynton Beach, FL (US)

(21) Appl. No.: 15/147,439

(22) Filed: May 5, 2016

Related U.S. Application Data
(60) Provisional application No. 62/157,642, filed on May 6, 2015.

(51) Int. Cl. H02G 3/08; F21V 9/16

(52) U.S. Cl. CPC H02G 3/081; F21V 9/16

(57) ABSTRACT

Wall plates for accommodating light switches, electrical outlets, telephone and data jacks, cable TV jacks and other electrical connections and devices are contemplated, wherein the wall plates are partially or entirely formed of rare earth materials to provide a luminescent property that emits a highly visible glowing light in dark or near dark conditions and environments. In a preferred embodiment, one or more rare earth elements are combined with a plastic composition for molding the wall plates so that the entire wall plate emits the glowing light. In another embodiment, a rare earth composite material is applied to a portion or the entire exposed surface of the previously molded wall plates. In still a further embodiment of the invention, the wall plates are molded of a plastic composition or other suitable composition and one or more inserts formed of rare earth materials are fitted to the molded wall plates.

This non-provisional patent application is based on provisional patent application Ser. No. 62/157,642 filed on May 6, 2015.

### BACKGROUND OF THE INVENTION

Field of the Invention

The present invention relates to wall plates for light switches, electrical outlets, telephone and data jacks, and the like, and, more particularly, to luminescent wall plates that emit a glowing light in dark or dim light conditions to assist with locating light switches, electrical outlets, telephone and data jacks and other electrical connections and devices.

Discussion of the Related Art

Light switches, electrical outlets, telephone and data jacks, cable TV jacks and other electrical connections and devices are typically installed within a metal or plastic box that is mounted within a wall. Light switches, electrical outlets, telephone and data jacks, and the like are then connected to wires or cables that extend within the interior of the wall and have terminal ends within the box. For both safety and cosmetic purposes, the box opening in the wall is covered with an appropriate wall plate. Wall plates are specifically designed to accommodate various styles of light switches, electrical outlets, as well as telephone and data jacks, cable TV jacks and other electrical connections and devices. When properly attached, the wall plate covers the box and all electrical connections and has specifically shaped openings to allow passage of the light switch, electrical outlet, telephone and data jacks and other devices therethrough.

In dark or dim light conditions, it is difficult to locate light switches, electrical outlets and other connection devices that are mounted within the wall. This is particularly problematic when a person is not familiar with the location of a light switch or electrical outlet, such as in a hotel room. However, even in one's own bedroom, it can be difficult to locate a light switch when the room is dark. Moreover, it is dangerous to attempt to plug in an electrical device to an electrical outlet when it is dark and the electrical outlet is not clearly visible.

Accordingly, there remains an urgent and definite need for a luminescent wall plate for light switches, electrical outlets, telephone and data jacks, cable TV jacks and the like, and wherein the luminescent wall plates are adapted to receive a charge of light in a relatively short period of time and to emit a highly visible glowing light in dark and dim light conditions for an extended period of time of at least three hours.

### SUMMARY OF THE INVENTION

The present invention is directed to wall plates for accommodating light switches, electrical outlets, telephone and data jacks, cable TV jacks and other electrical connections and devices. The wall plates are partially or entirely formed of rare earth materials to provide a luminescent property that emits a highly visible glowing light in dark or near dark conditions and environments. In a preferred embodiment, one or more rare earth elements are combined with a plastic composition for molding the wall plates so that the entire wall plate emits the glowing light. In another embodiment, a rare earth composite material is applied to a portion or the entire exposed surface of the previously molded wall plates. In still a further embodiment of the invention, the wall plates are molded of a plastic composition or other suitable composition and one or more inserts formed of rare earth materials are fitted to the molded wall plates.

### DETAILED DESCRIPTION OF THE PREFERRED EMBODIMENTS

The present invention proposes to form wall plates out of a luminescent material that emits a glowing light during dark and dim light conditions. The wall plates are specifically designed to accommodate light switches, electrical outlets, telephone and data jacks, cable TV jacks and other electrical connections and devices. In one embodiment, the wall plates are molded from a plastic composition that includes one or more rare earth elements therein. In another embodiment, a rare earth composite material is applied to a portion or the entire exposed surface of the wall plates. In still a further embodiment of the invention, the wall plates are molded of a plastic composition and inserts formed partially or entirely of rare earth materials are fitted to the molded wall plates.

In the preferred embodiment, the luminescent material is comprised of one or more rare earth materials that are incorporated within the plastic composition or other material composition during the molding process. The rare earth materials are adapted to be quickly charged with light energy from the sun or electric powered lights within a room. Moreover, the rare earth materials are adapted to emit a luminescent glowing light for an extended period of time of at least three hours.

The rare earth elements and composite materials used in the wall plates of the present invention include, but are not limited to, photoluminescent materials such as aluminate photoluminescent pigment, silicate photoluminescent pigment and nitrides photoluminescent pigment.

What is claimed is:

1. A wall plate for covering an electrical connection box built into a wall, said wall plate comprising:
a unitary body formed at least partially of a rare earth photoluminescent material capable of being charged with light energy and further structured to emit a luminescent light from the charge of light energy continuously for at least three hours.

2. The wall plate as recited in claim 1 wherein the rare earth photoluminescent material is aluminate photoluminescent pigment.

3. The wall plate as recited in claim 1 wherein the rare earth photoluminescent material is silicate photoluminescent pigment.

4. The wall plate as recited in claim 1 wherein the rare earth photoluminescent material is nitrides photoluminescent pigment.

5. A method of manufacturing wall plates for covering electrical connection boxes containing light switches, electrical outlets, telephone and data jacks, and television jacks, said method comprising the steps of:
providing a rare earth photoluminescent material capable of being charged with light energy and further structured to emit a luminescent light from the charge of light energy continuously for at least three hours; and
molding the wall plates using a composition that includes the rare earth photoluminescent material.

6. The method as recited in claim 5 wherein the rare earth photoluminescent material is aluminate photoluminescent pigment.

7. The method as recited in claim 5 wherein the rare earth photoluminescent material is silicate photoluminescent pigment.

8. The method as recited in claim 5 wherein the rare earth photoluminescent material is nitrides photoluminescent pigment.

9. A method of manufacturing wall plates for covering electrical connection boxes containing light switches, electrical outlets, telephone and data jacks, and television jacks, said method comprising the steps of:
providing a rare earth photoluminescent material capable of being charged with light energy and further structured to emit a luminescent light from the charge of light energy continuously for at least three hours;
molding the wall plates into desired shapes and configurations to include an exposed front surface; and
applying the rare earth photoluminescent material to at least the exposed front surface of the molded wall plates.

10. The method as recited in claim 9 wherein the rare earth photoluminescent material is aluminate photoluminescent pigment.

11. The method as recited in claim 9 wherein the rare earth photoluminescent material is silicate photoluminescent pigment.

12. The method as recited in claim 9 wherein the rare earth photoluminescent material is nitrides photoluminescent pigment.
